(19) United States
(12) Patent Application Publication
(10) Pub. No.: US 2017/0237326 A1
(43) Pub. Date: Aug. 17, 2017

(54) SYNCHRONOUS ROTATION MOTOR OR GENERATOR PROVIDED WITH DIVERSE ROTORS AND/OR STATORS

(71) Applicant: Beremundo Elsio Cicilia, Saint Eustatius and Saba (NL)

(72) Inventor: Beremundo Elsio Cicilia, Saint Eustatius and Saba (NL)

(21) Appl. No.: 15/506,114

(22) PCT Filed: Sep. 2, 2015
(86) PCT No.: PCT/NL2015/050608

§ 371 Date: Feb. 23, 2017

(30) Foreign Application Priority Data
Sep. 2, 2014 (NL) 2013403

(51) Int. Cl. H02K 21/24

(52) U.S. Cl. CPC H02K 21/24; H02K 2201/06

(57) ABSTRACT

The present invention provides a device comprising a housing; a shaft mounted rotatably in or on the housing and having at least one shaft end extending through a side wall of the housing; one, two or more magnetic segments coupled to the rotatable shaft and comprising first magnets; and second magnetic segments which are coupled to the housing and extend between the first magnetic segments in radial direction and which are provided with second magnets, wherein the first magnets are electromagnets and the second magnets are permanent magnetic segments, or vice versa.

The present invention relates to an electric motor or generator which can be applied in a wide variety of applications such as for an electrical generator and can be used to drive vehicles, vessels and aircraft.

The present invention relates to a device comprising:

a housing;

a shaft mounted rotatably in or on the housing and having at least one shaft end extending through a side wall of the housing;

two or more magnetic segments coupled to the rotatable shaft and comprising a first magnet; and

second magnetic segments which are coupled to the housing and extend between the first segments in axial and radial direction and which are provided with second magnets, wherein the first magnets are electromagnets and second magnets are permanent magnetic segments, or vice versa.

The above stated device can be used both as generator and as motor, depending on the manner of connection. Because the magnets are placed on both sides between other magnets, an extremely strong and compact electric motor (or generator) is provided.

As a result of the present invention a motor will be less likely to malfunction and will start more easily than other motors.

The housing preferably comprises aluminium or other non-ferrous material.

The shaft is preferably of steel.

In a preferred embodiment the permanent magnets are arranged rotatably, wherein the stator is provided with electromagnets.

Because the magnet is placed on both sides between other magnets, both poles of the magnets are utilized and an extremely strong electric motor (or generator) is hereby provided.

It will be apparent that, depending on the application, different voltages, amperages or frequencies can be applied with the motor (or generator) according to the present invention.

In the preferred embodiment the magnetic segments of the magnetic discs are offset in each case relative to each other and arranged on the shaft so that a start capacitor can be dispensed with (or can have an extremely small capacitance).

Although the first preferred embodiment of the present invention relates to a motor, various aspects can likewise be applied as a generator.

Further advantages, features and details of the present invention will be elucidated on the basis of the following description of a preferred embodiment thereof, wherein reference is made to the accompanying drawings, in which:

FIG. 1 is a perspective view of a preferred embodiment of the present invention;

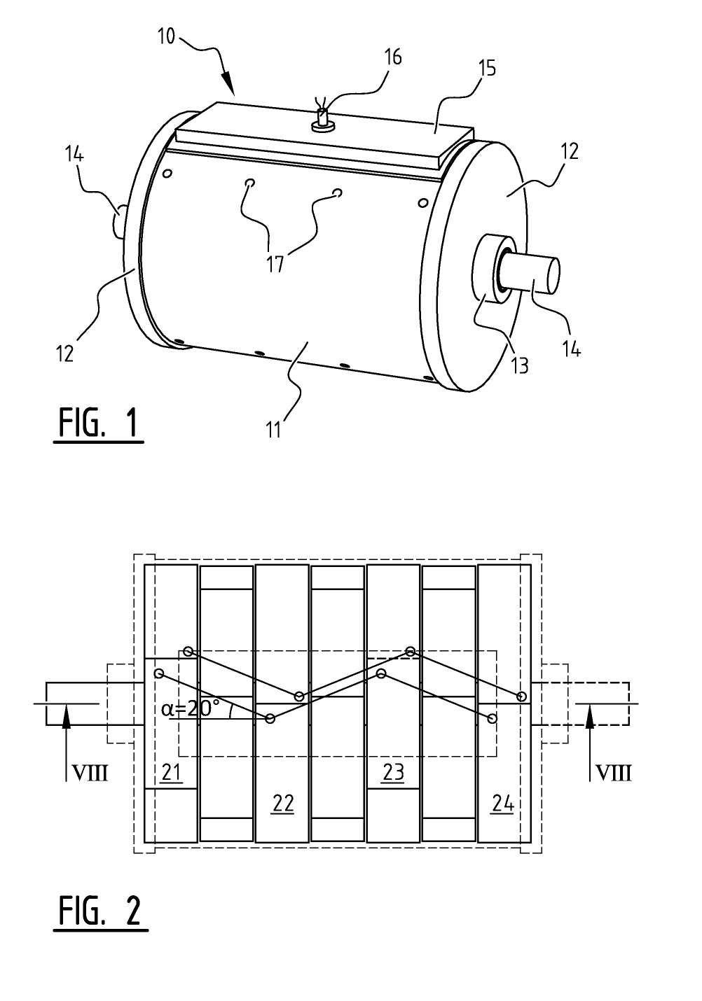

FIG. 2 is a schematic cross-sectional view of the preferred embodiment shown in FIG. 1;

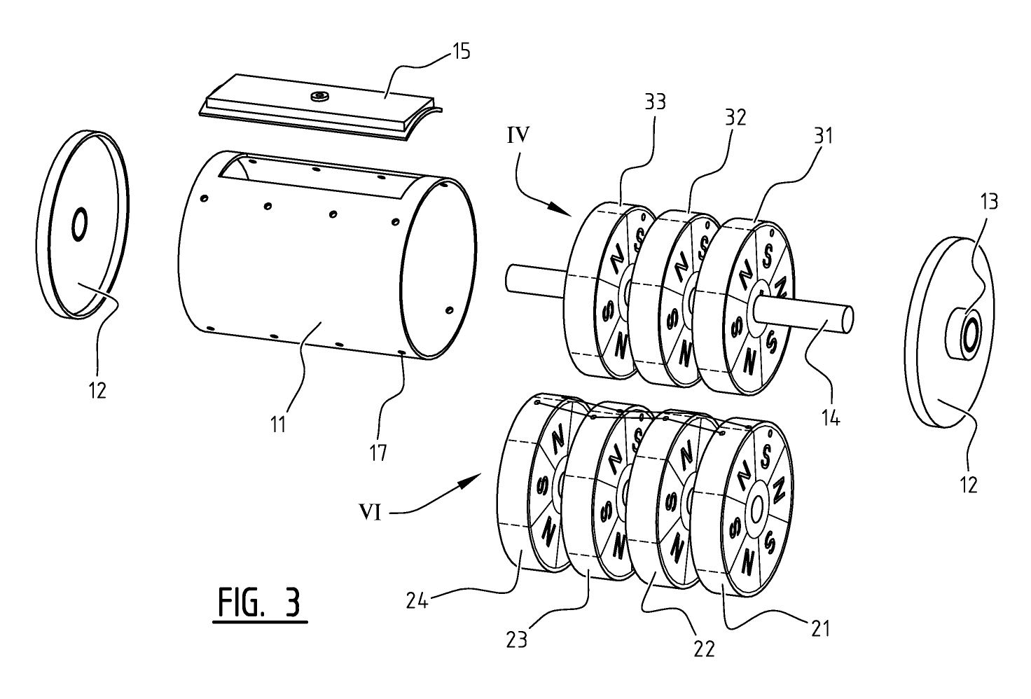

FIG. 3 is an exploded view of the preferred embodiment shown in FIGS. 1 and 2;

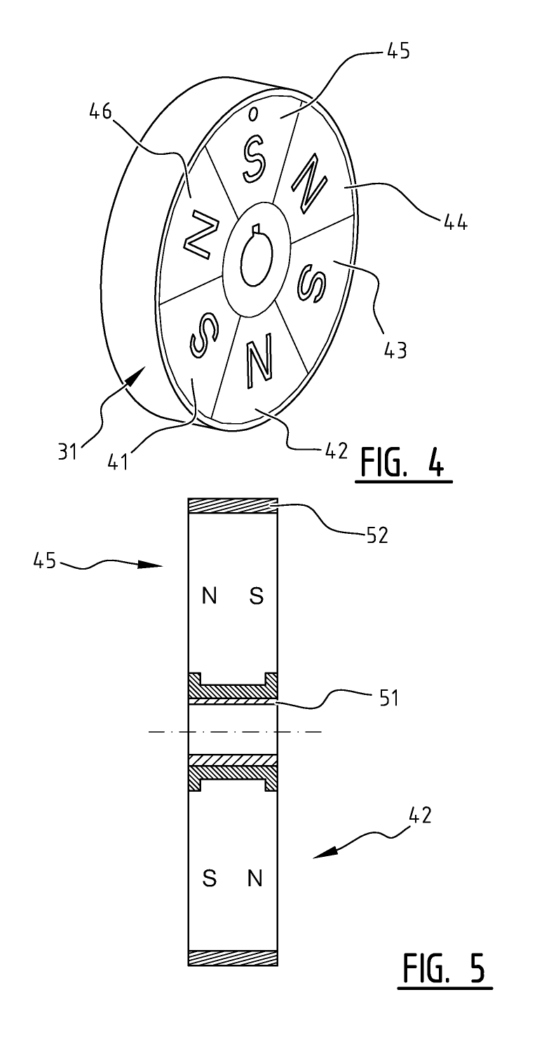

FIG. 4 is a perspective view of detail IV of FIG. 3;

FIG. 5 is a side view of a cross-section of the device shown in FIG. 4;

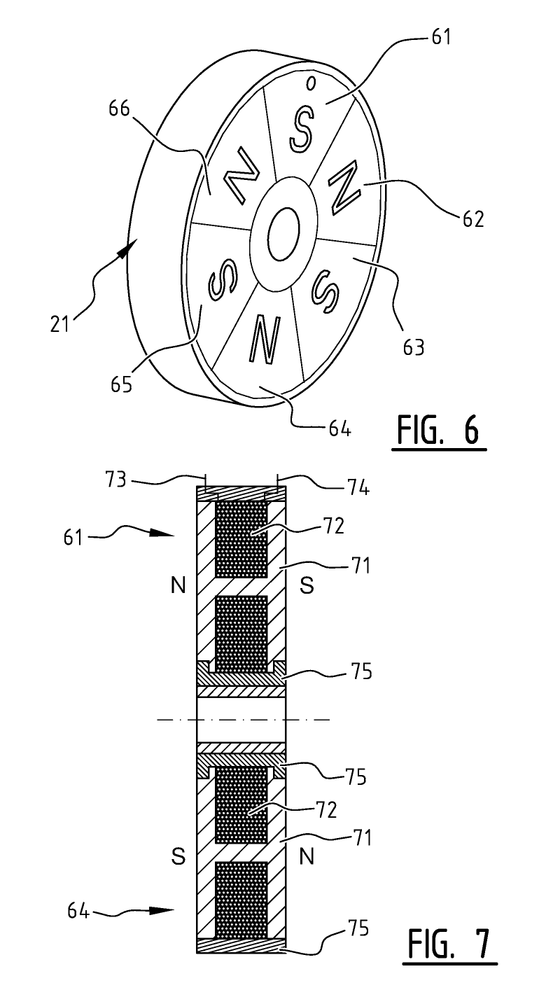

FIG. 6 is a perspective view of detail VI of FIG. 3;

FIG. 7 is a cross-sectional view of the component shown in FIG. 6; and

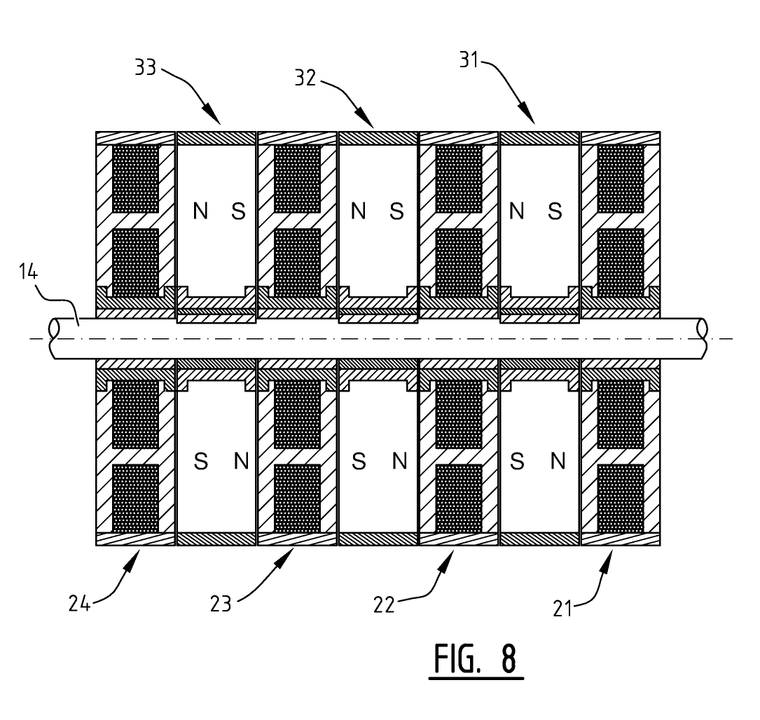

FIG. 8 is a side view of a cross-section along line VIII in FIG. 2 of the preferred embodiment shown in FIGS. 1, 2 and 3.

Motor/generator 10 (FIG. 1) comprises a substantially cylindrical housing 11 with disc-like end covers 12 which are arranged thereon and each provided with a bearing 13 for a shaft 14. Cylindrical housing 11 is also provided with a removable upper cover 15 for electrical connection, maintenance and the like into which an opening is recessed for an electrical cable 16 for the purpose of connection thereof.

Holes 17 are arranged in cylindrical housing 11. Electromagnetic discs 21, 22, 23, 24 are screwed fixedly via holes 17 (FIG. 2, 3). Three permanent magnetic discs 31, 32, 33 are arranged on shaft 14 between these four discs 21, 22, 23, 24 and are therefore rotatable relative to the electromagnetic discs 21, 22, 23, 24 arranged fixedly on the housing.

A permanent magnetic disc 31 preferably comprises six magnetic segments 41, 42, 43, 44, 45, 46 (FIG. 4, 5) which are arranged in each case between a sliding sleeve 51 and an outer ring 52. A magnetic segment 45 comprises on the left-hand side (FIG. 5) a magnetic north pole (N) and on the right-hand side a magnetic south pole (S), while this is reversed in opposite magnetic segments 42.

An electromagnetic disc 21 (FIG. 6) comprises six electromagnetic segments 61, 62, 63, 64, 65, 66 which are arranged on the rotatable shaft and comprises electric wiring 72 wound therearound in each case with a yoke 71, and two schematically designated terminal contact points 73, 74. Also shown are end yokes 75.

During assembly of the device according to the present invention the segments 21, 22, 23, 24 with the electromagnets are screwed fixedly to the housing and the permanent magnetic discs 31, 32, 33 are placed therebetween, wherein an assembly is formed of stator discs 21, 22, 23, 24 and rotor discs 31, 32, 33 alternately placed adjacency of each other. FIG. 8 shows a section of such an assembly. Shaft 14 is then placed therethrough and fixed to the permanent magnetic discs, after which the cover discs 12 are pushed on both sides over shaft ends 14.

As shown particularly in FIGS. 1 (and 3), the fixed magnets are preferably arranged offset relative to each other on the housing, for instance with an angle α of about 20° in each case.

The present invention is not limited to the above described preferred embodiments; the rights sought are defined by the following claims, within the scope of which many modifications can be envisaged.

In the above description and following claims a magnet is understood to mean a stand-alone piece of ferrous material with a magnetic charge, an electromagnet is understood to mean a stand-alone winding, optionally provided with a core which becomes magnetic when connected to an electrical source; a magnetic disc is understood to mean a disc with magnets or electromagnets, a rotor is understood to mean a shaft to which two or more magnetic discs are fixed, a stator is understood to mean one or more magnetic discs disposed fixedly via the housing or in other manner, and a magnetic segment is understood to mean a (partial) magnetic disc.

1. A device, comprising:
a housing;
a shaft mounted rotatably in or on the housing and having at least one shaft end extending through a side wall of the housing;
one, two or more magnetic segments coupled to the rotatable shaft and comprising first magnets; and
second magnetic segments which are coupled to the housing and extend between the first magnetic segments in radial direction and which are provided with second magnets, wherein the first magnets are electromagnets and the second magnets are permanent magnetic segments, or vice versa.

2. The device as claimed in claim 1, wherein the disc arranged on the shaft comprises in each case a number of permanent magnetic segments, wherein adjacent magnets have in each case an opposite polarity.

3. The device as claimed in claim 2, wherein a disc comprises six or more magnetic segments.

4. The device as claimed in claim 1, wherein the magnetic segments of the two or more magnetic discs coupled to the rotatable shaft are offset in each case through 20°.

5. The device as claimed in claim 1, wherein the electromagnets are connected electrically to each other.

6. The device as claimed in claim 1, wherein the shaft is connected rotatably and the device is provided with electrical terminals for drawing off an electric current or voltage.

7. The device as claimed in claim 1, wherein an electric current/voltage is applied to the electromagnet, whereby the rotatable shaft is driven.
